(19) United States
(12) Patent Application Publication
(10) Pub. No.: US 2004/0161531 A1
(43) Pub. Date: Aug. 19, 2004

(54) Process and apparatus for the application of glue to packaging material

(75) Inventors: Ingo Ferber, Verden (DE); Thomas Kracke, Bremen (DE)

Correspondence Address: SUGHRUE MION, PLLC, 2100 Pennsylvania Avenue, NW, Washington, DC, 20037-3213, US

(73) Assignee: FOCKE & CO (GmbH & Co.)

(21) Appl. No.: 10/751,102

(22) Filed: Jan. 5, 2004

(30) Foreign Application Priority Data
Jan. 8, 2003 (DE) 103 00 485.8

(51) Int. Cl. B05D 5/10; B05C 11/00

(52) U.S. Cl. 427/207.1; 118/665; 118/688

(57) ABSTRACT

During the application of glue, in particular hot-melt glue, to a material web (21) for blanks, the transfer of glue is dependent on the conveying speed of the material web (21) and other parameters. In particular, a glue pressure, which is exerted on the glue in accordance with the movement of the material web, is regulated by means of a pressure control valve (37) which is connected to a central machine control unit (31). This ensures a uniform delivery of glue.

The invention relates to a process for applying glue, in particular glue of the hot-melt type, to packaging material as it is transported during the application of glue, preferably to a continuous material web used for the production of blanks, by means of glue nozzles having closable nozzle openings, which are supplied with glue under pressure—glue pressure—during a phase of glue application onto the packaging material. Furthermore, the invention relates to an apparatus for implementing this process.

The application of glue to packaging material—be it individual blanks or a continuous material web—presents a special problem for high-performance packaging machines. This is particularly the case with respect to the manufacture of cigarette packs with packaging machines having short cycle periods. The packaging material, in this case the material web in particular, is transported while the glue is applied. The glue assemblies employed for this purpose are preferably equipped with contact glue nozzles. The packaging material thus lies against the mouths or nozzle openings of the contact glue nozzles when glue is applied. The application of glue by means of contact glue nozzles is known from EP 0 765 81 1.

The object of the invention is to propose measures for influencing the areas of glue applied to the packaging material in accordance with the respective task at hand.

In order to achieve this object, the process according to the invention is characterized in that the glue pressure acting on the glue can be adjusted on an individual basis as determined by the conveying speed of the packaging material or material web and/or by the viscosity of the glue and/or by a layer thickness of the glue areas to be applied to the packaging material.

According to the invention, the glue pressure exerted on the glue in the glue assembly or in the region of the glue nozzles can be set according to a number of parameters. Thus, at greater conveying speeds it is not only a higher glue pressure which is effective. Glue behavior (viscosity) must also be taken into account. Finally, the thickness of the glue area to be generated on the packaging material plays a role in determining the glue pressure.

A special feature of the invention is a dynamic control of glue pressure that is adapted to the current conveying speed of the packaging material. In particular, this involves measuring the change in the rotation angle of a resolver and calculating a velocity value, in particular in terms of work cycles. The velocity value is calculated with a algorithm stored in the control unit to arrive at an appropriate pressure value. As an alternative to this cyclical calculation of glue pressure, the invention makes it possible to store a curve in the control unit which is characteristic for each format, i.e. for each size and/or shape of blanks to be produced. The actual format to be processed can then be selected. The thickness of the applied glue can be altered by making a shift in the (pressure) curve.

According to the invention, the glue assembly is connected to a (central) machine control unit which directs the regulation of the glue pressure, in particular by means of a pressure control valve in a glue line leading to the glue assembly. The glue entering the glue assembly therefore always has the required glue pressure as based on the parameters to be considered.

The apparatus according to the invention employs a contact glue nozzle configured as a flat injector. The flat injector has a plurality of nozzle openings which can be actuated individually or in groups. The (cyclical) conveying movement of the material web is gauged and the result sent to the central machine control unit. The latter controls individual shut-off devices of the nozzles, the supply of glue by means of a glue pump, the pressure control valve and a compressed air control unit for the pressure control valve. In addition, the apparatus has a data input unit, in particular a PC, by means of which the parameters for setting the glue pressure can be entered individually at the production site.

Further special features of the invention are described in more detail below as based on the drawings, which show:

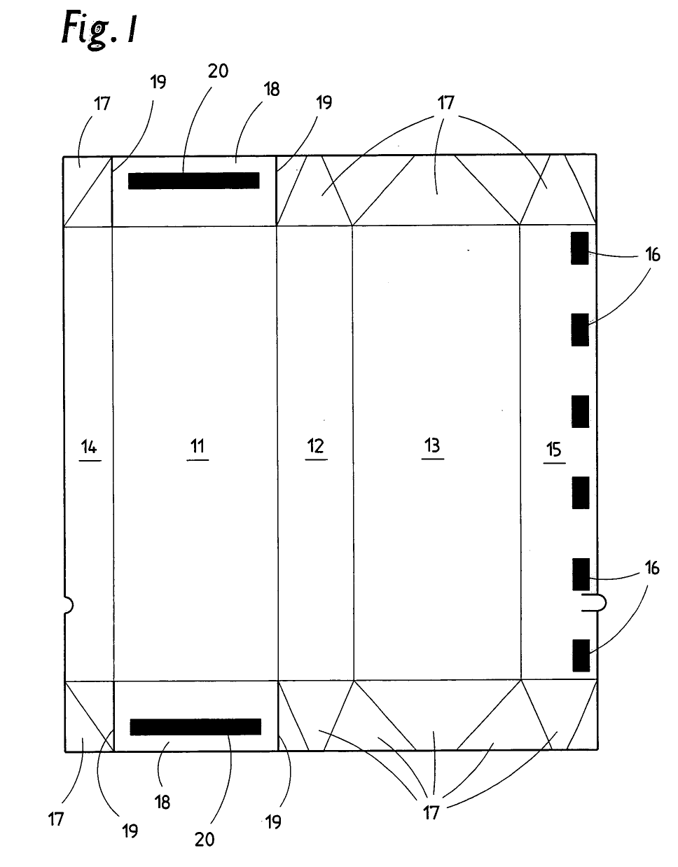

FIG. 1: a spread-out blank with one glue pattern,

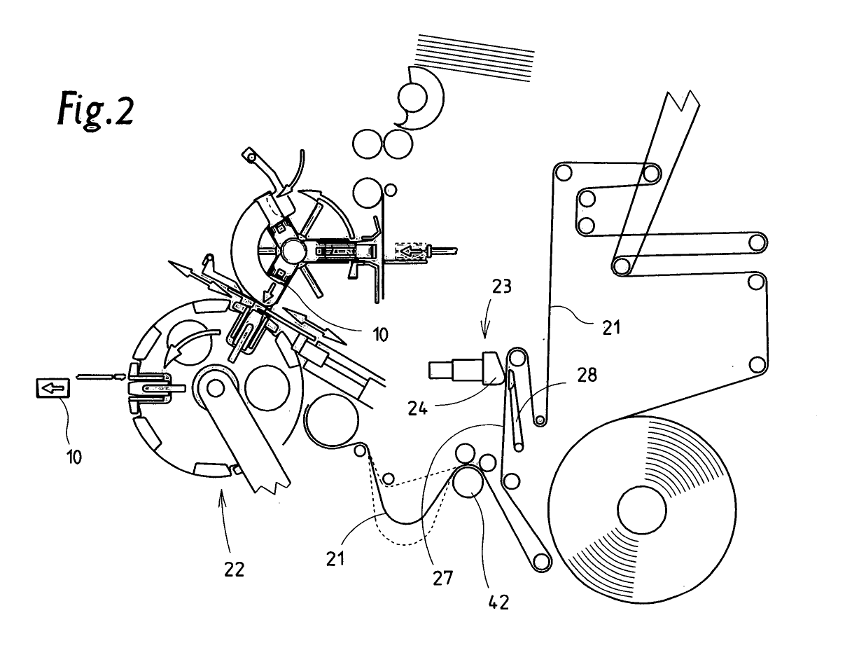

FIG. 2: a schematic side view of part of a packaging machine for manufacturing cigarette packs,

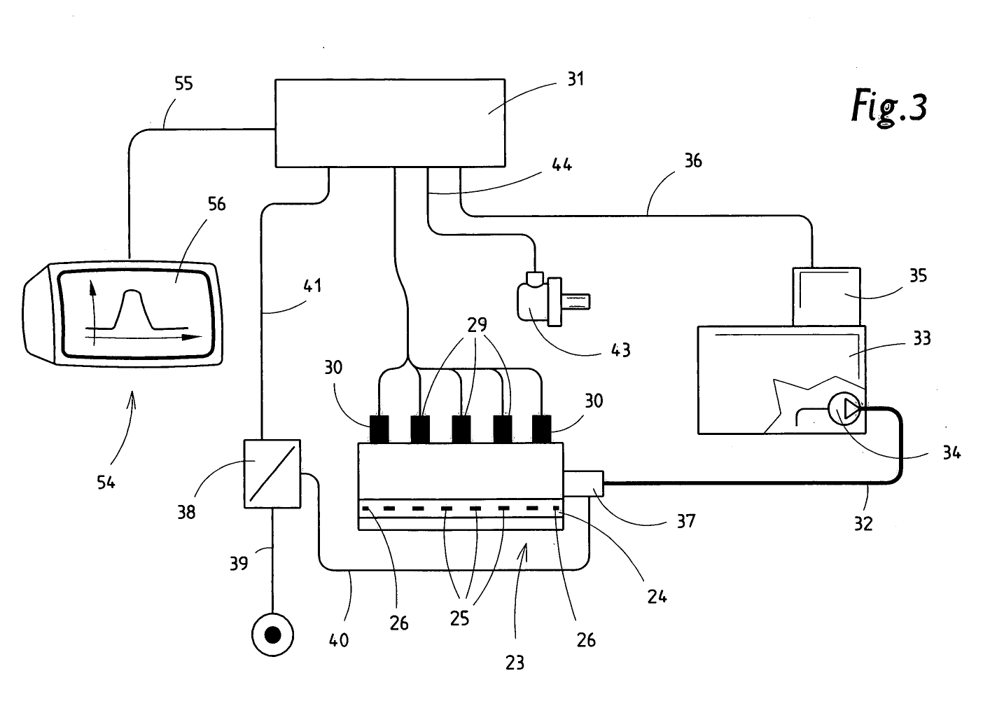

FIG. 3: a schematic circuit diagram of a glue unit,

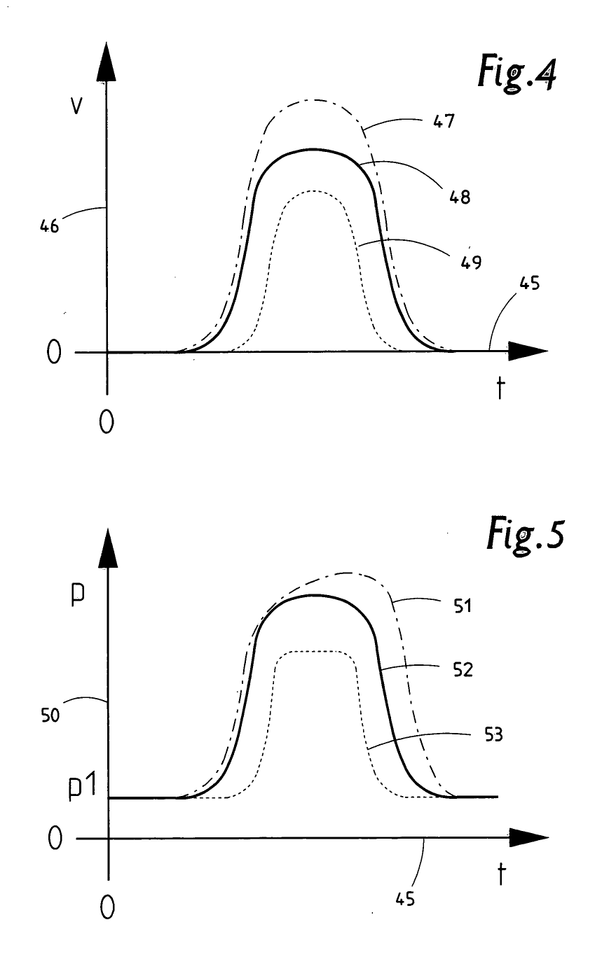

FIG. 4: a diagram of the motion sequence of a material web,

FIG. 5: a diagram of the pressure sequence (glue pressure) for one gluing cycle.

According to FIG. 1, glue is to be applied to a blank made of paper, coated paper or film. The blank is designed as the outer wrapper for a cigarette pack, namely for a bundle pack 10 (cigarette carton). The blank forms a front wall 11, a side wall 12 and a rear wall 13. A side wall opposite side wall 12 comprises two mutually overlapping folding tabs, namely edge strips 14, 15. These are adhesively connected to each other by glue at their (partial) overlap. For this purpose, the outer, broader edge strip 15 is provided with glue on its inner side, namely with a number of glue areas 16. The elongate edge strip 15 is therefore not provided with a continuous strip of glue but rather with a plurality of spaced, rectangular glue areas 16, specifically in the present case with six glue areas.

Provided for the formation of the mutually opposite end walls of the bundle pack 10 are marginal end tabs 17 and a respective cover tab 18 as the outer cover of the end walls. Its dimensions correspond essentially to the dimensions of the end wall. The cover tab 18 is delimited from the bordering end tabs 17 by punched cuts 19. The cover tab 18 is also provided with glue, namely with an elongate glue strip 20.

During production of the bundle pack the blank is severed from a continuous material web 21 and fed to a folding turret 22. In the region of the latter the blank is directly folded around a group of cigarette packs or—in the shown example—around a bundle pack 10 that has already been formed. The glue areas 16 and glue strips 20 applied to the blank (FIG. 1) consist of hot-melt glue. This hardened glue is heat-activated after the edge strips 14, 15 and the end tabs 17, 18 are respectively folded, with the folding tabs being joined to one another through the application of pressure, specifically in the region of the folding turret 22.

The (initially) fluid glue is applied by a glue assembly 23 to the material web 21. The glue assembly 23 has a glue nozzle 24, specifically a flat injector or a plurality of flat injectors with a number of adjacent, slit-shaped nozzle openings 25, 26. The glue for forming the glue areas 16 or glue strips 20 is applied by means of contact of the material web 21 with the glue assembly and its nozzle openings 25, 26. For this purpose the glue assembly 23 is positioned in the region of an essentially upright web section 27 of the material web 21. The material web, which at this point is conveyed in a downward direction, is applied or pressed against the glue assembly 23 at least during the period of glue application, specifically in the region of the glue openings 25, 26. For this purpose a displaceable, namely pivoting pressure-exerting element 28 which temporarily presses the material web 21 against the glue nozzle 24.

The blanks (FIG. 1) are positioned within the material web 21 such that the walls 11 . . . 15 follow each other in the conveying direction. The glue patterns, namely glue areas 16, on one hand, and glue strips 20, on the other, are determined, on one hand, by the width of the nozzle openings 25, 26 transverse to the conveying direction, and on the other hand, by the duration of action or opening of the nozzle openings 25, 26, namely concerning the dimension of the glue areas in the material web's 21 direction of movement. The marginal nozzle openings 26 serve to apply the glue strips 20 during their corresponding open period. The adjacent glue areas 16 are created simultaneously by the corresponding number of nozzle openings 25, with their open period being correspondingly shorter.

Accurate control and regulation of the glue assembly 23 is important for the creation of precise glue patterns. Each nozzle opening 25, 26, or plurality of nozzle openings 25 is assigned a shut-off device, namely an (electric) valve 29, 30. The two middle valves 29 are each assigned to a plurality of nozzle openings 25 (three) and each of the valves 30 are assigned to the marginal nozzle openings 26. Control of the valves 29 is carried out as a function of the working cycle of the glue assembly 23 or of the packaging machine, specifically, in the special exemplary embodiment at hand, by a (central) machine control unit 31 of the packaging machine.

The glue, in particular in its hot-melt embodiment, is fed to the glue assembly 23 via a (common) glue line 32. This line is preferably heated, namely when hot-melt glue is employed. The glue is taken from a glue tank 33 and forced into the glue line 32 under pressure exerted by a glue pump 34. In the glue line 32 a relatively high pressure is generated, namely up to 20 bar. The glue feed and the glue pump 34 are controlled by a control unit 35, which is connected to the machine control unit 31 by means of a signal line 36.

A special feature of the invention is its precise control over the amount of dispensed glue such that a constant application of glue is ensured which is 30 controllable with respect to the thickness of the glue layer, regardless of the relative motion between the material web 21 and the glue assembly 23, and regardless of the glue's properties. For this purpose it is possible to regulate the pressure exerted on the glue in the region of the glue nozzles 24, or in the region of the nozzle openings 25, 26, and thus on the glue pressure itself.

The glue pressure is determined by a common pressure control valve 37. This valve is attached to the side of a housing of the glue assembly 23 and determines the glue pressure for the entire glue nozzle 24 and all nozzle openings 25, 26, specifically in the region of the glue line 32. As an alternative, it is possible to employ a plurality of addressable pressure control valves (in the glue assembly 23) in order to regulate nozzle openings on an individual or group basis with respect to the effective glue pressure. The glue pressure determined by the pressure control valve 37 lies between 4 bar and a maximum of 20 bar.

Control of the pressure control valve 37 is executed by a compressed air control unit 38, which is connected by means of a compressed air line 39 to a source of compressed air, on one hand, and by means of a compressed air line 40 to the pressure control valve 37, on the other.

A special feature is the adjustability of the glue pressure by means of a data input device, which in the exemplary embodiment of FIG. 3 is a PC 54. This computer is connected to the control unit or to the machine control unit 31 via a signal line 55. A display screen 56 shows the entered data, which is represented graphically here. The PC 54 is equipped for entering variable specifications or parameters, in particular those concerning special glue characteristics that are relevant to processing operations, such as glue viscosity. Furthermore, it is possible to specify the desired layer thickness of the glue on the packaging material. The PC can therefore be used to set the glue pressure such that the glue strips 20 have a layer thickness that is different from that of the glue areas 16. The open period and the opening cycle of the nozzle openings 25, 26—in particular as a function of the size of the blanks to be produced in each case—can be entered into the machine control unit 31. Other data and parameters to be taken into account, such as the conveying speed of the material web at any given time, are fed to the machine control unit 31 elsewhere.

In the shown exemplary embodiment, the conveying movement of the material web 21 is directly ascertained in the region of the material web 21. For this purpose, an element which revolves in accordance with the conveying speed, in particular one of the two draw rollers 42 for the material web, is assigned a scanning device, namely a resolver 43. The latter detects the movement of the material web 21 by virtue of the rotation of the draw roller 42. The resolver 43 is also connected to the machine control unit 31 by means of a signal line 44. Accordingly, the machine control unit 31 detects the movement sequence of the material web 21 during its (cyclical) draw. Subsequently, the pressure control valve 37 is activated by the compressed air control unit 38 with the result that a glue pressure is generated in the glue nozzle 24 which corresponds to the conveying movement and other parameters as necessary. The required open period of the nozzle openings 25, 26 is appropriately determined by the valves 29, 30.

The interaction between the conveying speed of the material web 21 and other parameters, on one hand, and the corresponding glue pressure is shown by the exemplary graphs in FIG. 4 and FIG. 5.

FIG. 4 shows a horizontal time axis 45 and a vertical velocity axis 46. The plotted lines 47, 48, 49 relate to the velocity curve for various dimensions (sizes) of blanks and the corresponding draw lengths and conveying speeds of the material web 21. The line 47 shows the velocity plot for a larger blank with the correspondingly greater maximum speed. The line 49 refers to a smaller blank with its characteristic curve of movement.

This interaction is also shown in FIG. 5 with the horizontal time axis 45 and vertical pressure axis 50. The lines 51, 52, 53 correspond in content to the lines 47, 48, 49 of FIG. 4. FIG. 5 shows the pressure plot and the pressure level as a function of time. Each of the lines 51, 52, 53 or curves can be assigned one of the curves or lines 47, 48, 49 of the diagram pursuant to FIG. 4. This means that a work or movement cycle pursuant to line 47, i.e. with the maximum speed of the material web 41, can be assigned a (pressure/time) line 53, and thus a relatively lower pressure, if due to the set parameters, such as glue viscosity and/or the desired layer thickness, a pressure plot corresponding to line 53 is appropriate. Furthermore, the curves, or lines 51, 52, 53, may have a non-uniform plot in order to represent the fact that the pressure can be deliberately altered during a work cycle, i.e. during a gluing phase, in accordance with the set program. A greater layer thickness in the glue strips 20 is desired for the blank according to FIG. 1 because a thicker layer fixes the fold in the region of the end walls. The glue areas 16 for connecting the edge strips 14, 15 can have a lesser layer thickness because a sufficient fixation can be achieved by the plurality of glue areas 16.

The glue pressure is dynamically regulated by adapting to the current conveying speed of the material web. In particular, the change in the rotation angle of the resolver 43 is determined cyclically, for example at intervals of 6 ms, and converted into a velocity value. This value is calculated with an algorithm stored in the control unit to arrive at the respective pressure value, essentially using the equation

p=p₁+m·v

Where p is the velocity-dependant glue pressure, p₁ is a set minimum pressure (FIG. 5), m is a factor according to the individually adjustable thickness of the glue layer and v is a number analogous to the web velocity. In addition, it is also possible to take other parameters into account, namely different values for the layer thickness of glue areas.

The shown method of glue application on packaging materials can also be applied during the transport of individual, pre-fabricated blanks. Furthermore, its use is also advisable when working with material webs transported in cyclical fashion when such webs run at non-uniform speeds, for example during start-up of the packaging machine and any delays in its operation.

| | |
|---|---|
| 10 | bundle pack |
| 11 | front wall |
| 12 | side wall |
| 13 | rear wall |
| 14 | edge strip |
| 15 | edge strip |
| 16 | glue area |
| 17 | end tab |
| 18 | cover tab |
| 19 | punched cut |
| 20 | glue strip |
| 21 | material web |
| 22 | folding turret |
| 23 | glue assembly |
| 24 | glue nozzle |
| 25 | nozzle opening |
| 26 | nozzle opening |
| 27 | web section |
| 28 | pressure-exerting element |
| 29 | valve |
| 30 | valve |
| 31 | machine control unit |
| 32 | glue line |
| 33 | glue tank |
| 34 | glue pump |
| 35 | control unit |
| 36 | signal line |
| 37 | pressure control valve |
| 38 | compressed air control unit |
| 39 | compressed air line |
| 40 | control air line |
| 41 | signal line |
| 42 | draw roller |
| 43 | resolver |
| 44 | signal line |
| 45 | time axis |
| 46 | velocity axis |
| 47 | line |
| 48 | line |
| 49 | line |
| 50 | pressure axis |
| 51 | line |
| 52 | line |
| 53 | line |
| 54 | PC |
| 55 | signal line |
| 56 | display screen |

1. Process for the application of glue, in particular glue of the hot-melt type, to packaging material transported during the application of glue, preferably to a continuous material web used for the production of blanks for packs, by means of glue nozzles (24) with closeable nozzle openings (25, 26); which are supplied with glue under pressure—glue pressure—during a phase of glue application onto the packaging material, characterized in that the glue pressure acting on the glue can be adjusted on an individual basis as determined by the conveying speed of the packaging material or material web (21) and/or by the viscosity of the glue and/or by a desired layer thickness of the glue regions—glue areas (16) and glue strips (20)—on the packaging material.

2. Process according to claim 1, characterized in that, for the purpose of producing blanks with a plurality of glue regions for different tasks, in particular with glue areas (16) for the purpose of connecting edge strips (14,15) of the blank and glue strips (20) for the purpose of fixing folding tabs of an end wall, the glue regions are set in accordance with their function through the regulation of the glue pressure during a gluing cycle or during the conveying movement of the packaging material in order to achieve the desired glue layer thickness.

3. Process according to claim 1 or 2, characterized in that the glue pressure and/or the opening phases of the glue nozzles (24) or of the nozzle openings (25, 26) are regulated by a common control unit, in particular by a (central) machine control unit (31).

4. Process according to claim 1, characterized in that the glue pressure is altered during a phase of glue application or during a work cycle, in particular for the purpose of generating glue regions—glue areas (16), glue strips (20)—with a different glue layer thickness.

5. Process according to claim 1, characterized in that the characteristic line of movement of the material web (21) to be glued is determined in the region of a deflection or draw roller (22) of the material web (21), preferably by a resolver (43) which is connected to the common control unit.

6. Process according to claim 1, characterized in that the material web (21) is conveyed in the region of the glue assembly (23) in a non-uniform manner, in particular in fixed-cycle operation, with the material web (21) accelerating from the standstill state to a maximum velocity, then being transported as necessary at a constant conveying speed and subsequently decelerated back to the standstill state, with the glue pressure being dynamically adjusted to the instantaneous speed by the control unit.

7. Process according to claim 1, characterized by the following features:
a) the conveying speed of the packaging material is determined cyclically on the basis of a change in the rotation angle of the resolver (43) and converted to a velocity value,
b) the velocity value is calculated with an algorithm stored in the control unit to arrive at an appropriate pressure value, namely glue pressure.

8. Apparatus for the application of glue, in particular glue of the hot-melt type, to packaging material transported during the application of glue, preferably to a continuous material web (21) used for the production of glued blanks, it being possible to move the packaging material, in particular the material web (21), past a glue assembly (23) that has closeable nozzle openings (25, 26), preferably making contact with the nozzle openings (25, 26) at least during the application of glue, characterized in that the pressure acting on the glue within the glue assembly (23) or in the glue nozzle (24), namely the glue pressure, can be regulated as determined by the conveying speed of the packaging material or of the material web (21) and/or by the viscosity of the glue and/or by the intended thickness of the glue layer.

9. Apparatus according to claim 8, characterized in that the glue assembly (23) has as a glue nozzle (24) a slit nozzle with a plurality of slit-like nozzle openings (25, 26) which can be closed individually or in groups, preferably by means of electronically activated shut-off devices or valves (29, 30) which are assigned to each nozzle opening (26) or to a group of nozzle openings (25) and which are connected to the common control unit.

10. Apparatus according to claim 8 or 9, characterized in that the glue assembly (23) or the glue nozzle (24) is supplied with glue though a glue line (32), with a pressure control element, preferably a pressure control valve (37), being arranged in the glue line (32), in particular directly at the glue assembly (23).

11. Apparatus according to claim 10, characterized in that the pressure control valve (37) can be regulated by means of compressed air via a compressed air control unit (38), with the pressure control valve (37) or the compressed air control unit (38) being connected to the common control unit—machine control unit (31).

12. Apparatus according to claim 9, characterized in that the glue line (32) is connected to a supply of glue or glue tank (33) and is supplied with glue under high pressure by means of a glue pump (34).

13. Apparatus according to claim 8, characterized in that the conveying speed of the packaging material or of the material web (21) can be scanned in the region of a deflection roller of the material web (21), in particular at a draw roller (42), in particular by means of a resolver (43) associated with the roller.

14. Apparatus according to claim 8, characterized in that a data input device is assigned to each glue assembly (23) or to a group of glue assemblies, in particular a PC (54), into which individual parameters concerning the conveying speed of the packaging material and/or glue viscosity and/or the desired layer thickness of the glue regions can be entered, with the data input device, or PC (54), being connected to the common control unit, in particular to the machine control unit (31), by means of a signal line (55).
